(19) United States
(12) Patent Application Publication
(10) Pub. No.: US 2023/0083413 A1
(43) Pub. Date: Mar. 16, 2023

(54) LASER CUTTING METHOD AND LASER CUTTING APPARATUS

(71) Applicant: TRUMPF Werkzeugmaschinen SE + Co. KG, Ditzingen (DE)

(72) Inventor: Tobias Kaiser, Rutesheim (DE)

(21) Appl. No.: 18/058,279

(22) Filed: Nov. 23, 2022

Related U.S. Application Data
(63) Continuation of application No. PCT/EP2021/064357, filed on May 28, 2021.

(30) Foreign Application Priority Data
May 28, 2020 (DE) 102020206670.1

(51) Int. Cl. B23K 26/38; B23K 26/073; B23K 26/082; B23K 26/064

(52) U.S. Cl. CPC B23K 26/38; B23K 26/0732; B23K 26/082; B23K 26/064; B23K 26/0869

(57) ABSTRACT

A method for laser cutting a workpiece includes the steps of guiding a laser beam over the workpiece in a cutting direction so as to produce a cutting kerf with two cutting flanks and melting material on the workpiece at a cutting front that extends between the cutting flanks and adjoins at least one of the cutting flanks at an angle. The laser beam has a non-circular cross section and, at a front of the laser beam in the cutting direction, a continuous cutting beam contour corresponding to the cutting front.

### CROSS REFERENCE TO RELATED APPLICATIONS

This application is a continuation of International Application No. PCT/EP2021/064357 (WO 2021/239953 A1), filed on May 28, 2021, and claims benefit to German Patent Application No. DE 10 2020 206 670.1, filed on May 28, 2020. The aforementioned applications are hereby incorporated by reference herein.

### FIELD

The invention relates to a method for laser cutting a workpiece, wherein a laser beam is guided over the workpiece in a cutting direction so that a cutting kerf having two cutting flanks is produced, wherein material is melted on the workpiece at a cutting front extending between the cutting flanks. The invention further relates to a laser cutting apparatus having a laser light source and a processing head for guiding a laser beam over a workpiece in a cutting direction.

### BACKGROUND

During laser cutting, material of a workpiece is typically melted at a cutting front by way of a laser beam. The molten material is then evacuated, that is to say removed from the workpiece, so that a cutting kerf is produced.

During cutting using solid-state lasers, molten material is frequently evacuated at some distance in the trailing region, that is to say at some distance behind the cutting front, and evacuation is frequently effected in a pulsed manner. Since the laser beam no longer heats, or maintains the temperature of, the molten material in the trailing region, the temperature of the molten material that is to be evacuated decreases as the distance from the cutting front increases. As a result, the viscosity of the molten material increases, and when the molten material is detached from a lower edge of the workpiece, some of the molten material remains stuck to the bottom side of the workpiece. This results in the formation of burrs. Furthermore, molten material can become stuck to the cutting flanks of the cutting kerf and solidify there, increasing the roughness of the cutting flanks.

DE 10 2007 059 987 B4 or WO 2008 052 547 A1 discloses cutting with two or more laser beams during laser cutting in order to improve the cutting edge quality, wherein a leading laser beam melts the material of the workpiece at a cutting front and performs the actual cutting process and wherein the trailing laser beam or laser beams serve(s) to (re-) heat the melt pool and to improve the evacuation of the molten material. According to WO 2008 052 547 A1, the trailing laser beams can also re-cut cutting edges.

### SUMMARY

In an embodiment, the present disclosure provides a method for laser cutting a workpiece that includes the steps of guiding a laser beam over the workpiece in a cutting direction so as to produce a cutting kerf with two cutting flanks and melting material on the workpiece at a cutting front that extends between the cutting flanks and adjoins at least one of the cutting flanks at an angle. The laser beam has a non-circular cross section and, at a front of the laser beam in the cutting direction, a continuous cutting beam contour corresponding to the cutting front

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic plan view of a workpiece during processing with a laser cutting method according to the invention, wherein a cutting front with two planar portions is formed, which are angled in relation to cutting flanks that delimit a cutting kerf;

FIG. 1b shows a schematic perspective view of the workpiece of FIG. 1a, wherein the workpiece is shown after it has been cut;

FIG. 2a shows a schematic cross section of a first laser beam with a cutting beam contour corresponding to the cutting front of the workpiece of FIG. 1a;

FIG. 2b shows a schematic cross section of a second laser beam with a cutting beam contour corresponding to the cutting front of the workpiece of FIG. 1a;

FIG. 2c shows a schematic cross section of a third laser beam with a cutting beam contour corresponding to the cutting front of the workpiece of FIG. 1a, wherein the laser beam is rotationally symmetric with respect to rotations by multiples of 90°;

FIG. 3a shows a schematic plan view of a workpiece during processing with a laser cutting method according to the invention, wherein a cutting front with two planar portions is formed, which are angled in relation to cutting flanks that delimit a cutting kerf, and wherein the cutting front has a plurality of kink sites;

FIG. 3b shows a schematic perspective view of the workpiece of FIG. 3a, wherein the workpiece is shown after it has been cut;

FIG. 4 shows a schematic plan view of a workpiece during processing with a laser cutting method according to the invention, wherein a cutting front with a plurality of planar portions is formed, which are angled in relation to cutting flanks that delimit a cutting kerf and with respect to one another;

FIG. 5a shows a schematic cross section of a first laser beam with a cutting beam contour corresponding to the cutting front of the workpiece of FIG. 4;

FIG. 5b shows a schematic cross section of a second laser beam with a cutting beam contour corresponding to the cutting front of the workpiece of FIG. 4;

FIG. 6 shows a schematic plan view of a workpiece during processing with a laser cutting method according to the invention, wherein a cutting front is embodied such that it is bent into a cutting kerf;

FIG. 7a shows a schematic cross section of a first laser beam with a cutting beam contour corresponding to the cutting front of the workpiece of FIG. 6, wherein the laser beam is rotationally symmetric with respect to rotations by multiples of 90°;

FIG. 7b shows a schematic cross section of a second laser beam with a cutting beam contour corresponding to the cutting front of the workpiece of FIG. 6;

FIG. 7c shows a schematic cross section of a third laser beam with a cutting beam contour corresponding to the cutting front of the workpiece of FIG. 6;

FIG. 8 shows a schematic plan view of a workpiece during processing with a laser cutting method according to the invention, wherein a cutting front with two planar portions is formed, which are angled in relation to cutting flanks that delimit a cutting kerf, and wherein a cutting front vertex projects into the cutting kerf counter to the cutting direction;

FIG. 9 shows a schematic cross section of a laser beam with a cutting beam contour corresponding to the cutting front of the workpiece of FIG. 8;

FIG. 10a shows a schematic perspective view of a workpiece during laser cutting with a round laser beam in a laser cutting method in accordance with the prior art, wherein the workpiece is shown after it has been cut;

FIG. 10b shows a schematic plan view of the workpiece of FIG. 10a;

FIG. 11 shows a schematic side view of a laser cutting apparatus according to the invention.

### DETAILED DESCRIPTION

It is an aspect of the invention to improve the cutting quality in laser cutting, in particular to reduce the formation of burrs at cutting edges.

Laser Cutting Method According to the Invention

According to the an embodiment of invention, a method for laser cutting a workpiece is provided. The workpiece typically consists of a metallic and/or electrically conductive material. The workpiece can be in the form of a metal sheet.

For cutting the workpiece, a laser beam is guided over the workpiece in a cutting direction so that a cutting kerf with two cutting flanks is produced. In the process, material is melted on the workpiece at a cutting front extending between the cutting flanks. Some of the molten material can be evaporated. The cutting flanks delimit the cutting kerf transversely to the cutting direction. The cutting front denotes the phase boundary between liquid and solid material of the workpiece. The laser beam can have a wavelength of at least 0.2 μm, preferably at least 0.4 μm. The laser beam can have a wavelength of at most 6 μm, preferably at most 4 μm. The laser beam can be produced by a solid-state laser.

According to an aspect of the invention, the cutting front adjoins at least one of the cutting flanks, preferably both cutting flanks, not tangentially but at an angle. The angle at the boundary between the cutting flank and the cutting front in principle is greater than zero. In other words, a transition between the cutting front and the cutting flank is not smooth. The angled transition from the cutting front to the cutting flank can also be referred to as a discontinuous transition. In particular, at the transition between the cutting front and the cutting flank, a tangential plane to the cutting front is inclined by the angle with respect to a tangential plane to the cutting flank. In the present invention, a tangential transition (that is to say a transition with a vanishing angle, as it is known from the prior art) is not understood to mean adjoining at an angle.

Also according to an aspect of the invention, the laser beam has a non-circular cross section. At the front when viewed in the cutting direction, the laser beam has a continuous cutting beam contour that corresponds to the cutting front. In other words, the shape of the cutting beam contour corresponds to the shape of the cutting front. The cutting beam contour of the laser beam in particular transversely to the cutting direction can here be smaller than the cutting front. The cutting front is formed in the manner described by the form of the cutting beam contour.

For the description of the cutting front and the cutting beam contour, reference is made in each case to the current cutting direction. The description of the shape of the laser beam refers in particular to a cross section of the laser beam that is acting on the workpiece or is intended to act on the workpiece.

Owing to the angle at the boundary between the cutting front and the cutting flank, or cutting flanks, the flowing out of the molten material onto the cutting flank(s) is opposed by a resistance that prevents or at least reduces the streaming out of the molten material onto the cutting flank(s). According to the invention it has been found that when the molten material is evacuated directly at a vertex of the cutting front, burr formation at the cutting flank can be avoided. Even if a burr were to arise initially near the cutting front vertex, for example if the molten material is evacuated inhomogeneously, this burr will be cut again when the cutting front moves forward and will therefore no longer be present on the finished cut component. A good quality of the cutting flanks can therefore be obtained with the laser cutting method according to an aspect of the invention. It can also improve the removability of cut-out parts of the workpiece because the danger of workpiece portions catching on one another on either side of the cutting kerf is reduced.

By contrast, in laser cutting methods known from the prior art, cutting usually takes place with a rotationally symmetric (typically round) laser beam. This produces a cutting front that has a semicircular shape both at the upper side and also the lower side of the metal sheet. Due to evaporation effects and turbulent flow of the molten material, in particular when using a solid-state laser, a flow of the molten material can have an increasingly horizontal velocity vector (that is to say with an increasing or preponderant component in the metal sheet plane). The molten material consequently flows laterally around the laser beam onto the cutting flanks. The cutting front shape that is semicircular in the prior art promotes the flow of the molten material onto the already cut flanks because these cutting flanks adjoin the semicircular shape of the cutting front tangentially. This overflow of the molten material onto the already cut cutting flanks causes burrs to form and moreover increases the surface roughness of the cutting flanks. This additionally decreases the removability of the cut parts from the sheet skeleton because what are known as overlapping striations could occur at the cutting flanks.

The laser cutting method according to the invention is preferably carried out with a laser cutting apparatus according to the invention, which is described below. Features of the laser cutting method described in connection with the laser cutting apparatus can be provided in the laser cutting method according to the invention.

In order to promote the evacuation of the molten material from the cutting kerf, cutting gas in a gas jet can be aimed at the workpiece.

A distance of a cutting front vertex from the transition between the cutting front and the cutting flank can be at least half the size of a cutting kerf width and/or at most the same size as the cutting kerf width. The molten material is evacuated as close to the cutting front vertex as possible. The cutting front vertex denotes the boundaries of the cutting front that are arranged frontmost or rearmost when viewed in the cutting direction and at a distance from the transitions to the cutting flanks. The cutting front vertex typically lies centrally between the cutting flanks. The distance is measured in the cutting direction. With a correspondingly shaped cutting beam contour, it is also possible to form more than one vertex at the cutting front. The cutting front then has a W-shaped profile, for example. The cutting kerf width is measured perpendicular to the cutting direction and typically perpendicular to the cutting flanks between the cutting flanks.

The angle between the cutting front and the cutting flank can be at least 30°, preferably at least 60°, with particular preference at least 90°, and very particularly preferably at least 120°. With an angle of this size, an overflow of molten material onto the cutting flanks can be avoided particularly effectively. In particular, the molten material can be prevented from flowing onto the cutting flank the more effectively, the greater the angle between the cutting front and the cutting flank is.

Advantageously, at least one kink site at which adjacent portions of the cutting front are angled with respect to one another is formed within the cutting front. The at least one kink site further reduces a flow of the molten material in the direction of the cutting flanks. The kink site extends in the thickness direction typically through the workpiece. The cutting beam contour of the laser beam has one or more corresponding kink site(s).

The cutting beam contour can be produced by moving the laser beam back and forth (scanning). In other words, an overall surface which is irradiated by the laser beam and is bounded at the front when viewed in the cutting direction by the cutting beam contour can be produced by quickly moving an (in relation to the overall surface) small laser beam over this overall surface.

Alternatively or additionally, diffractive and/or refractive optical elements can be used to produce the cutting beam contour of the laser beam. Provision can also be made for the laser beam to emerge from an optical fiber core having the shape of the cutting beam contour.

The laser beam can have at least one further cutting beam contour that corresponds to the cutting front and is arranged rotated around a beam axis of the laser beam. The further cutting beam contour makes it possible to change the cutting direction in a manner such that the further cutting beam contour lies at the front when viewed in the new cutting direction. The laser beam, or a beam shaping unit that gives the laser beam the cutting beam contour corresponding to the cutting front, then does not need to be rotated in order to correspondingly change the cutting direction.

The laser beam is preferably rotationally symmetric with respect to rotations by predetermined rotation angles about its beam axis, in particular with respect to rotations by multiples of 90°. If the laser beam has, for example, a fourfold rotational symmetry, the laser beam has a (first) cutting beam contour and three further cutting beam contours. Rectangles can then be cut out without the laser beam or a beam shaping device being rotated. In order to cut parts of any desired shape, a fourfold rotationally symmetric laser beam merely needs to be rotated by a maximum of 45°. A twofold rotationally symmetric laser beam (rotational symmetry with respect to a rotation by 180°) with two cutting contours that lie opposite each other needs to be rotated only by a maximum of 90° in order to cut parts of any desired shape. The symmetry relates in particular to that cross section of the laser beam that is acting on the workpiece.

The laser beam is advantageously mirror symmetric, in particular with respect to a plane parallel to the cutting direction. At its two lateral ends, the cutting front then adjoins at the same angle the cutting flanks of the cutting kerf. When planning manufacturing, there is then no need to pay attention to which side of the cutting direction a good part should be arranged on. Both cutting flanks can be produced with the same quality.

Alternatively, provision may be made for the laser beam not to be mirror symmetric. In particular, an angle may be formed only at the transition between the cutting front and one of the cutting flanks. This can simplify the provision of the laser beam with the corresponding cutting beam contour. The cutting direction should then be selected such that a good part is arranged on that side that has the angled transition between the cutting flank and the cutting front.

With particular preference, the cutting front is convex when viewed in the cutting direction. In other words, a cutting front vertex lies, when viewed in the cutting direction, behind the angled transition between the cutting front and the cutting flank. The cutting front vertex is directed into the interior of the cutting kerf, as it were. The cutting front does not need to be shaped in the form of a circular arc. The cutting front can have, for example, a triangular or W-shaped profile, with one or more acutely tapered cutting front vertices directed into the interior of the cutting kerf being formed. In this variant of the method, it is particularly advantageous that the molten material that is forced to the side due to evaporation effects also flows to the cutting front center in order to be evacuated there. Should a burr form at the center of the cutting front, said burr is reliably re-cut during the further cutting process and in this way removed from the workpiece.

The improved evacuation of the molten material can be supported by the choice of further process parameters. A high cutting gas pressure evacuates the molten material faster and consequently closer to the cutting front. However, a higher pressure of the cutting gas is also associated with greater gas costs, which means that an optimum must be found here. In addition, a small distance between a nozzle for the cutting gas and the workpiece surface is useful because this also improves the introduction of cutting gas into the cutting kerf.

Laser Cutting Apparatus According to the Invention

The scope of the present invention also includes a laser cutting apparatus. The laser cutting apparatus serves for carrying out a method according to the invention as described above and is generally configured therefor. The laser cutting apparatus can have features described in connection with the laser cutting method.

The laser cutting apparatus has a laser light source. The laser light source emits a laser beam during the operation of the laser cutting apparatus. The laser cutting apparatus furthermore has a processing head. The processing head enables the laser beam to be guided over a workpiece in a cutting direction. To this end, the processing head and the workpiece can be moved relative to each other. The workpiece can be held on a workpiece support of the laser cutting apparatus.

According to the invention, the laser cutting apparatus has a beam shaping device that gives the laser beam a continuous cutting beam contour that lies at the front when viewed in the cutting direction, wherein the cutting beam contour adjoins a passive contour of the laser beam at a contour angle at a point of the laser beam that is outermost transversely to the cutting direction. The laser beam that is shaped in such a way makes it possible when cutting the workpiece to set the described transition between a cutting front and a cutting flank at an angle. The cutting beam contour of the laser beam brings about in this case the melting of the material of the workpiece at the corresponding cutting front. The passive contour can extend in portions parallel to the cutting flank. The passive contour already typically extends toward the cutting kerf center immediately behind the lateral outermost point. In the region of the passive contour, the molten material can be continued to be heated or the cooling-off thereof may be prevented. This makes it easier to evacuate the molten material. The passive contour can further reduce the risk of molten material sticking to the cutting flank.

The laser light source can include a solid-state laser. The laser light source can emit laser light having a wavelength of at least 0.2 μm, preferably at least 0.4 μm, and/or at most 6 μm, preferably at most 4 μm.

The laser cutting apparatus can have a rotary device in order to rotate the beam shaping device relative to a machine bed and/or a workpiece support of the laser cutting apparatus. The rotation is preferably performed about a beam axis of the laser beam. The rotary device enables the cutting direction to be changed.

The beam shaping device can have diffractive and/or refractive optical elements. With a suitable design or combination of these optical elements, the laser beam having the described cutting beam contour can be produced.

Alternatively or additionally, the beam shaping device can have a scanning device in order to move the laser beam back and forth along the cutting beam contour. This allows for a simpler design of any optical elements that may be required. Shaping the cutting beam contour by moving the laser beam back and forth by means of the scanning device is suitable in particular for larger widths of the cutting kerf and greater workpiece thicknesses.

The beam shaping device can have an optical fiber core whose outer contour is such that it corresponds to the cutting beam contour and the passive contour of the laser beam. In order to focus the laser beam onto the workpiece, additional diffractive and/or refractive optical elements may be provided. The optical fiber core is typically an integral part of an optical fiber. Beam shaping by means of the optical fiber core can simplify the construction of the laser cutting apparatus.

Further features and advantages of the invention are evident from the description, the claims, and the drawing. According to the invention, the features mentioned above and those still to be further presented can be used in each case individually or together in any desired expedient combinations. The embodiments shown and described should not be understood as an exhaustive list, but rather are of an exemplary character for elucidating the invention.

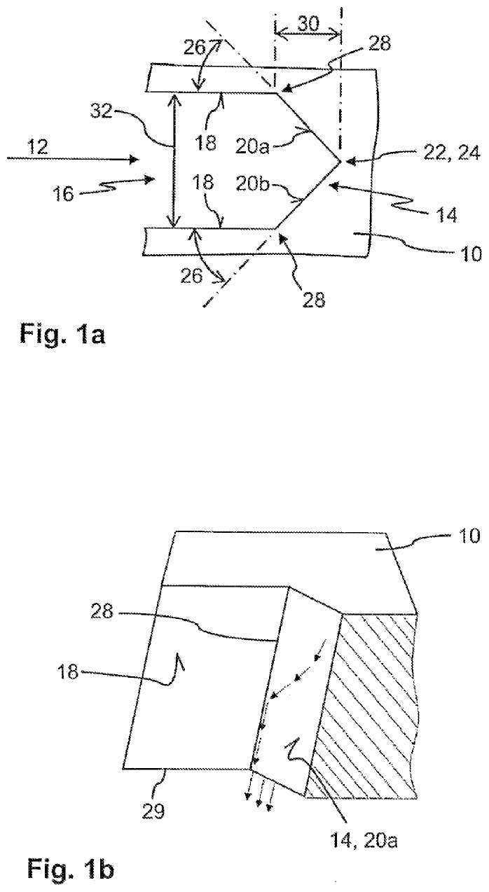

FIGS. 1a and 1b show a workpiece 10 during a laser cutting operation. During laser cutting, a laser beam is guided over the workpiece 10 in a cutting direction 12. In the process, material of the workpiece 10 is melted. The molten material adjoins the not yet melted, solid material of the workpiece 10 at a cutting front 14. The molten material is removed from the workpiece 10, typically with the aid of a gas jet, so that a cutting kerf 16 is produced. The cutting kerf 16 is delimited laterally (transversely to the cutting direction 12) by two cutting flanks 18.

The cutting front 14 is here formed with two planar portions 20a, 20b. The portions 20a, 20b of the cutting front 14 adjoin one another in a cutting front vertex 22. The cutting front vertex 22 corresponds here to the region of the cutting front 14 that lies the furthest at the front in the cutting direction 12. A kink site 24 is formed here at the cutting front vertex 22 between the portions 20a, 20b of the cutting front 14. Viewed from above, the cutting front 14 has the shape of a V.

The cutting front 14 adjoins the two cutting flanks 18 of the cutting kerf 16 in each case at an angle 26. In other words, transitions 28 between the cutting front 14 and the cutting flanks 18 are not smooth. The angle 26 here is 45°, for example. Both angles 26 are of equal size in this case. In general, the angles 26 of the cutting front 14 to the two cutting flanks 18 can be of different sizes. The angles 26 at the transitions 28 prevent the molten material from flowing out laterally, and it flows to the bottom in the channel that is formed (cf. flow arrows in FIG. 1b). This forces the molten material to be evacuated near the cutting front 14 and in particular in the region of the cutting front vertex 22. Solidification of molten material at the cutting flanks 18 and in particular at their lower cutting edges 29 can thus be avoided.

A distance 30, measured in the cutting direction 12, of the cutting front vertex 22 from the angled transitions 28 between the cutting front 14 and the cutting flanks 18 can be approximately 60% of the cutting kerf width 32.

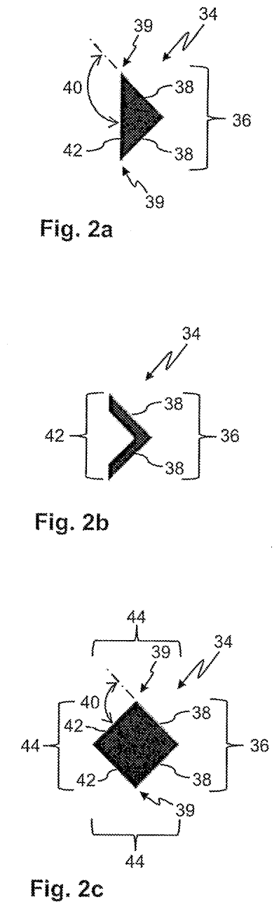

FIGS. 2a, 2b and 2c are cross sections of laser beams 34 which can be used when laser cutting the workpiece 10 according to FIGS. 1a and 1b. The laser beams 34 each have a cutting beam contour 36 corresponding to the cutting kerf 14. The cutting beam contour 36 and the cutting front 14 corresponding to each other means that they correspond to each other in terms of their shape. Typically, the cutting beam contour 36 is slightly smaller, in particular smaller transversely to the cutting direction 12, than the cutting front 14. The cutting beam contour 36 is embodied here such that it corresponds to two contour portions 38 which are at an angle relative to one another and have rectilinear cross sections. At points 39, which are laterally outermost with respect to the cutting direction 12, the cutting beam contour 36 adjoins a passive contour 42 of the laser beam 34 at a contour angle 40. During laser cutting, the passive contour 42 is not involved in melting the material of the workpiece 10 at the cutting front 14. Material of the workpiece 10 that has already melted in the region of the passive contour 42 can be continued to be heated or prevented from cooling.

The laser beams 34 in FIGS. 2a, 2b and 2c are each mirror symmetric to a middle plane parallel to the cutting direction 12.

The laser beam 34 in FIG. 2c is additionally rotationally symmetric with respect to rotations by multiples of 90° about its beam axis (perpendicular to the plane of the drawing). The laser beam 34 of FIG. 2c therefore has three further cutting beam contours 44. Cutting beam contours 36, 44 which follow one another are rotated relative to one another by 90° (about the beam axis of the laser beam 34 that is perpendicular to the plane of the drawing).

The cross section of FIG. 2b can be obtained for example by moving the laser beam 34 back and forth (scanning it) along the cutting beam contour 36. The cross sections of FIG. 2a and FIG. 2c can be obtained for example by combining diffractive and refractive optical elements or by a correspondingly shaped fiber core of an optical fiber.

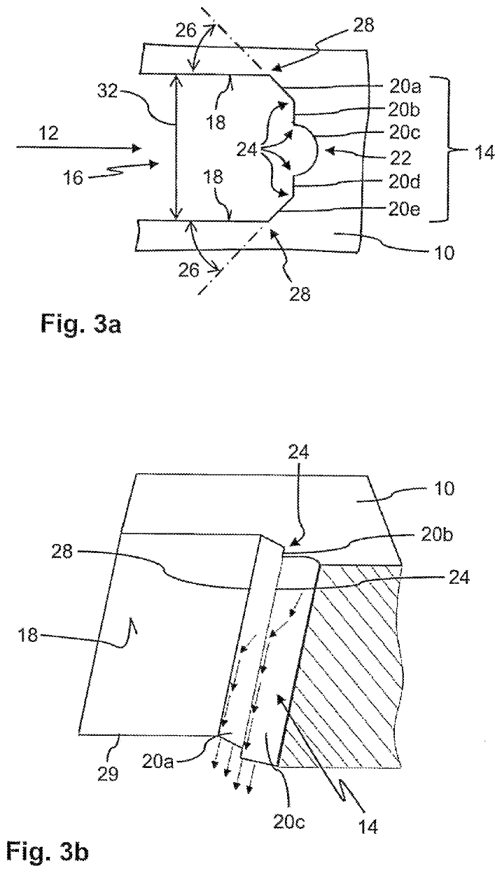

FIGS. 3a and 3b show a workpiece 10 during a laser cutting operation, wherein a cutting front 14 has a plurality of portions 20a-20e which are angled relative to one another at kink sites 24. The kink sites 24 reduce the amount of molten material that reaches an angled transition 28 between the cutting front 14 and cutting flanks 18 of a cutting kerf 16 (cf. flow arrows in FIG. 3b).

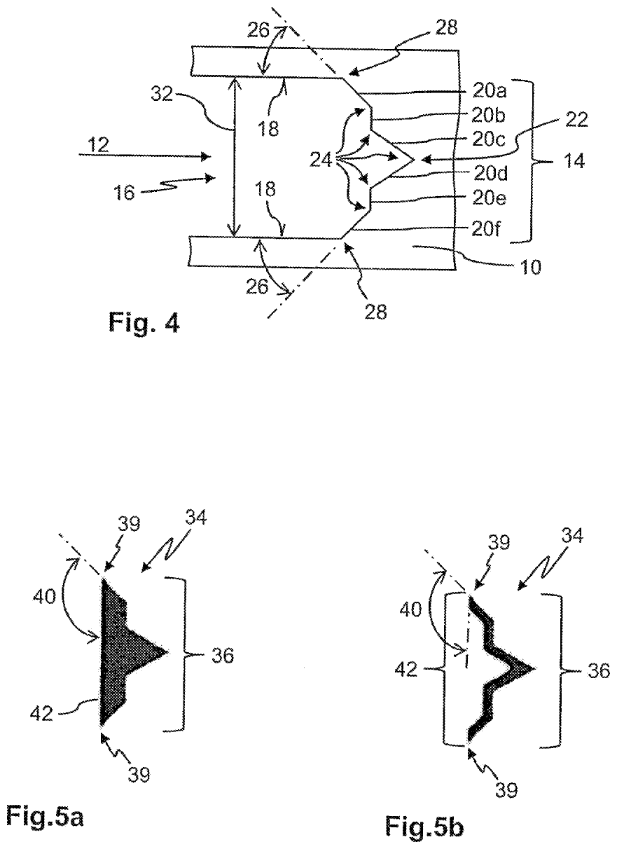

FIG. 4 shows a workpiece 10 during laser cutting, wherein a cutting front 14 is embodied similarly to the case of FIG. 3a but with six planar portions 20a-20f. FIGS. 5a and 5b show cross sections of laser beams 34 that have a cutting beam contour 36 corresponding to the cutting front 14 of the workpiece 10 in FIG. 4.

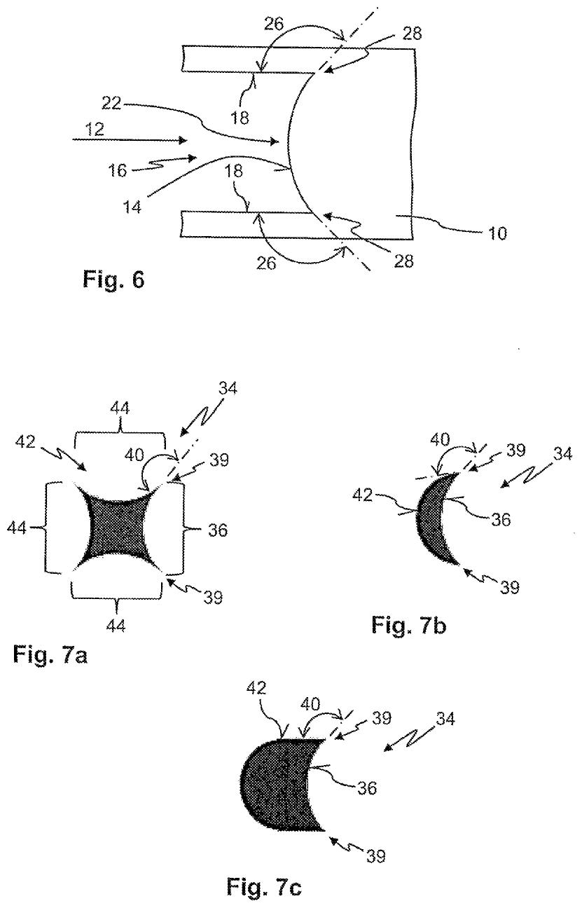

FIG. 6 shows a workpiece 10 during laser cutting, wherein a cutting front 14 is curved. A cutting front vertex 22 in this case forms the rearmost point of the cutting front 14 when viewed in the cutting direction. When viewing the cutting front 14 in the cutting direction 12 from the top, it appears convex.

FIGS. 7a, 7b and 7c are cross sections of laser beams 34 which can be used when laser cutting the workpiece 10 of FIG. 6. The laser beams 34 each have a cutting beam contour 36 corresponding to the cutting front 14.

The laser beams 34 in FIGS. 7a, 7b and 7c are each mirror symmetric to a middle plane parallel to the cutting direction 12.

The laser beam 34 in FIG. 7a is additionally rotationally symmetric with respect to rotations by multiples of 90° about its beam axis. The laser beam 34 of FIG. 7a therefore has three further cutting beam contours 44. Cutting beam contours 36, 44 which follow one another are rotated relative to one another by 90° (about a beam axis of the laser beam 34 that is perpendicular to the plane of the drawing).

A passive contour 42 of the laser beam 34 of FIG. 7c extends in portions parallel to the cutting flanks 18 at the cutting kerf 16 of the workpiece 10. It is thus possible to effectively avoid solidification of molten material at the cutting flanks 18.

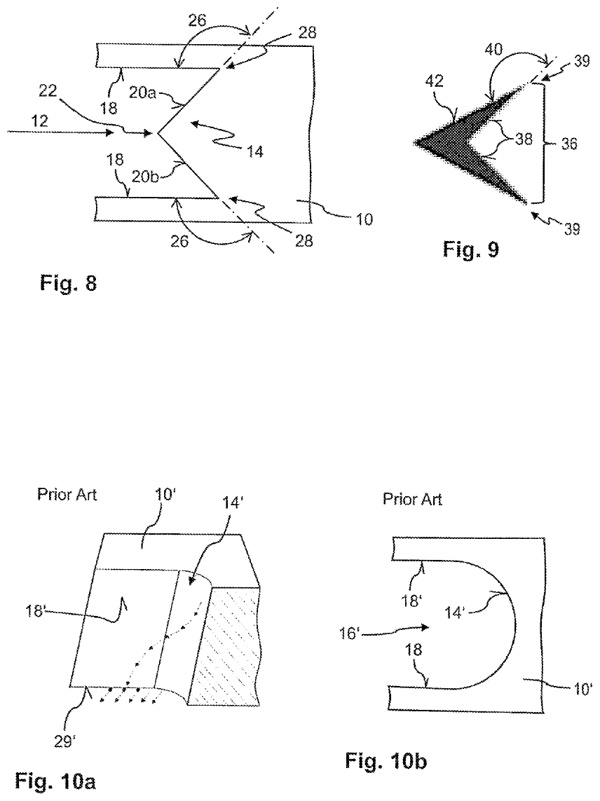

FIG. 8 shows a workpiece 10 during laser cutting, wherein a cutting front 14 is embodied as in the case of the workpiece of FIG. 6 so as to be convex when viewed in the cutting direction 12, but wherein the cutting front 14 has two portions 20a, 20b which are angled with respect to each other.

FIG. 9 shows a cross section of a laser beam 34 that has a cutting beam contour 36 corresponding to the cutting front 14 of the workpiece 10 in FIG. 8. A contour angle 40 is approx. 160° in this case. This enables an angled transition 28 between the cutting front 14 and cutting flanks 18 at the cutting kerf 16 of the workpiece 10 to be particularly sharp. An angle 26 between the cutting flanks 18 and the cutting front 14 can be 135°, for example.

As an alternative to the cutting beam contours 36 illustrated in FIGS. 2a-c, 5a-b, 7a-c and 9, the laser beam 34 can also have a star-shaped cutting beam contour (not illustrated in the figures). A star-shaped cutting beam contour produces a jagged cutting front corresponding to the star shape. A star-shaped cutting beam contour can be embodied preferably with 6, 9 or even 12 prongs or points. As the number of the prongs or points increases, the requirement to reorient the laser beam depending on the cutting direction can be eliminated.

FIGS. 10a and 10b show a workpiece 10′ during laser cutting with a laser beam having a circular cross section. In a laser cutting method of this type known from the prior art, a cutting front 14′, at which material of the workpiece 10′ is melted, tangentially (smoothly) transitions into a cutting flank 18′ of a cutting kerf 16′. As a result, molten material flows to a significant degree onto the cutting flank 18′ and deposits on the latter in the form of ripples and at the lower cutting-edge 29′ thereof in the form of a burr (cf. the flow arrows drawn in FIG. 10a).

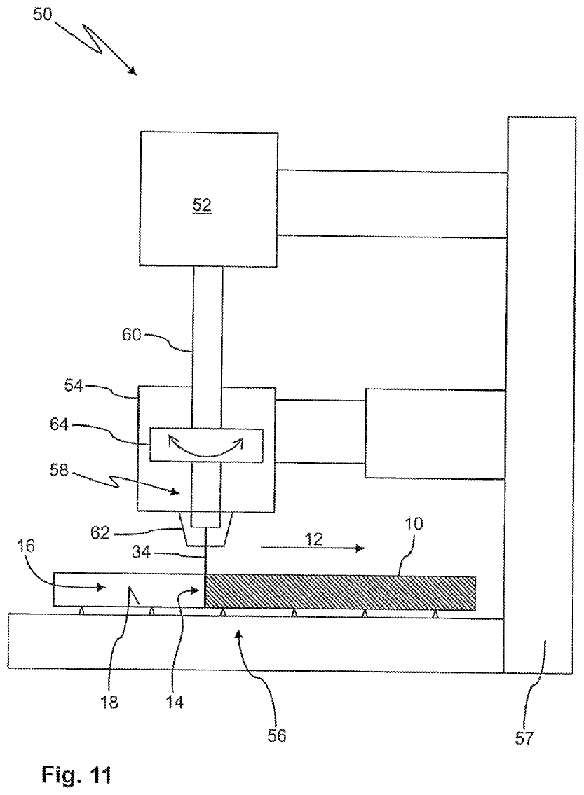

FIG. 11 shows a laser cutting apparatus 50. The laser cutting apparatus 50 has a laser light source 52, here with a solid-state laser. A laser beam 34 emitted by the laser light source 52 can have a wavelength of approx. 1 μm.

The laser cutting apparatus 50 furthermore has a processing head 54. The processing head 54 enables the laser beam 34 to be guided over a workpiece 10 in a cutting direction 12 to form a cutting kerf 16 that is delimited by cutting flanks 18, cf. also FIGS. 1a to 9. The workpiece 10 can be held on a workpiece support 56 of the laser cutting apparatus 50. The processing head 54 and the workpiece support 56 are movable relative to each other. The processing head 54 can for this purpose be guided on a machine bed 57 of the laser cutting apparatus 50 so as to be displaceable.

The laser cutting apparatus 50 furthermore has a beam shaping device 58. The beam shaping device 58 causes the light beam 34 to be incident on the workpiece 10 with a previously described cross section (cf. for example FIGS. 2a-2c, 5a, 5b 7a-7c, 9). Accordingly, a cutting beam contour 36 of the laser beam 34 transitions at a point 39 which is outermost transversely to the cutting direction 12 into a passive contour 42 at a contour angle 40. The cutting beam contour 36 melts the material of the workpiece 10 at a corresponding cutting front 14.

The beam shaping device 58 can have an optical fiber 60 with a fiber core (not illustrated in more detail). The laser beam 34 can be guided via the optical fiber 60 from the laser light source 52 to the processing head 54. A cross section of the fiber core can correspond to the cross section of the laser beam 34.

The laser beam 34 can emerge through a nozzle 62. The nozzle 62 is used to direct cutting gas in the form of a gas jet onto the workpiece 10 in order to support the evacuation of the molten material.

The laser cutting apparatus 50 additionally has a rotary device 64. The rotary device 64 enables the laser beam 34 to be rotated about its beam axis. As a result, the orientation of the cutting beam contour 36 in the cutting direction 12 at the front of the laser beam 34 can be maintained when the cutting direction 12 changes relative to the workpiece 10, for example when cutting along a curved line. The rotary device 64 can for this purpose rotate the beam shaping device 58 relative to the machine bed 57 of the laser cutting apparatus 50. In particular, the rotary device 64 can rotate the beam shaping device 58, here specifically a free end of the optical fiber 60, relative to the processing head 54.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Workpiece 10
Cutting direction 12
Cutting front 14
Cutting kerf 16
Cutting flanks 18
Portions 20a-20f of the cutting front 14
Cutting front vertex 22
Kink site 24
Angle 26
Transitions 28
Cutting edge 29
Distance 30
Cutting kerf width 32
Laser beam 34
Cutting beam contour 36
Contour portion 38
Outermost point 39
Contour angle 40
Passive contour 42
Further cutting beam contour 44
Laser cutting apparatus 50
Laser light source 52
Processing head 54
Workpiece support 56
Machine bed 57
Beam shaping device 58
Optical fiber 60
Nozzle 62
Rotary device 64

1. A method for laser cutting a workpiece, the method comprising:
guiding a laser beam over the workpiece in a cutting direction so as to produce a cutting kerf with two cutting flanks; and
melting material on the workpiece at a cutting front that extends between the cutting flanks and adjoins at least one of the cutting flanks at an angle,
wherein the laser beam has a non-circular cross section and, at a front of the laser beam in the cutting direction, a continuous cutting beam contour corresponding to the cutting front.

2. The method as claimed in claim 1, wherein a distance of a cutting front vertex from the transition between the cutting front and the cutting flank in the cutting direction is at least half the size of a cutting kerf width and/or at most the same size as the cutting kerf width.

3. The method as claimed in claim 1, wherein the angle between the cutting front and the cutting flank is at least 30°.

4. The method as claimed in claim 1, wherein adjacent portions of the cutting front are angled with respect to one another so as to form at least one kin site within the cutting front.

5. The method as claimed in claim 1, wherein the cutting beam contour is produced by moving the laser beam back and forth.

6. The method as claimed in claim 1, wherein the laser beam has at least one further cutting beam contour corresponding to the cutting front and is arranged rotated about a beam axis of the laser beam.

7. The method as claimed in claim 1, wherein the laser beam is rotationally symmetric with respect to rotations by predetermined rotation angles about a beam axis.

8. The method as claimed in claim 1, wherein the laser beam is mirror symmetric with respect to a plane parallel to the cutting direction.

9. The method as claimed in claim 1, wherein the cutting front is convex in the cutting direction.

10. A laser cutting apparatus for carrying out a method as claimed in claim 1, comprising:
a laser light source,
a processing head configured to guide a laser beam over a workpiece in a cutting direction,
a beam shaping device configured to provide the laser beam a continuous cutting beam contour that lies at a front of the laser beam in the cutting direction, wherein the cutting beam contour adjoins a passive contour of the laser beam at a contour angle at a point of the laser beam that is outermost transversely to the cutting direction.

11. The laser cutting apparatus as claimed in claim 10, wherein the laser light source includes a solid-state laser.

12. The laser cutting apparatus as claimed in claim 10, further comprising a rotary device configured to rotate the beam shaping device relative to a machine bed and/or a workpiece support of the laser cutting apparatus.

13. The laser cutting apparatus as claimed in claim 10, wherein the beam shaping device has diffractive and/or refractive optical elements.

14. The laser cutting apparatus as claimed in claim 10, wherein the beam shaping device includes a scanning device for moving the laser beam back and forth along the cutting beam contour.

15. The laser cutting apparatus as claimed in claim 10, wherein the beam shaping device includes an optical fiber core having an outer contour corresponding to the cutting beam contour and the passive contour of the laser beam.
